(19) United States
(12) Patent Application Publication
(10) Pub. No.: US 2003/0100262 A1
(43) Pub. Date: May 29, 2003

(54) Mobile communication terminal, embedded type communication device and storing medium

(76) Inventor: Kentaro Ma, Kanagawa (JP)

Correspondence Address: DARBY & DARBY P.C., P. O. BOX 5257, NEW YORK, NY, 10150-5257, US

(21) Appl. No.: 10/148,769

(22) PCT Filed: Jun. 20, 2001
(86) PCT No.: PCT/JP01/05275

(51) Int. Cl. H04B 5/00; H04B 17/00; H04B 7/00; H04Q 7/20

(52) U.S. Cl. 455/41; 455/67.1; 455/522

(57) ABSTRACT

The present invention is to provide a mobile communication terminal which sends a proper electric power even by using a general-purpose communication terminal and performs accurate billing processing in the use of Internet and the like.

A mobile communication terminal 1 restricts the output power of a radio device operated by an operation button 5 below the power defined by the radio wave regulation and sends the inherent information about a subscriber line to a PC3 which provides a service in order to require the information there.

The mobile communication terminal 1 restrains the transmission and reception of the subscriber line of the mobile communication terminal 1 by the operation of the operation button 5 and switches the sending and receiving protocol of the subscriber line exclusively to the protocol different from this so as to make it possible to perform only the communication with the PC3.

An embedded type communication device 2 installed in the PC3 performs the control to bill the subscriber line corresponding to the received inherent information and to establish a communication line with a service provider indicated in the Internet 4. The embedded type communication device 2 performs a communication control between the service provider and the PC3 connected by the communication line.

### TECHNICAL FIELD

The present invention relates to a mobile communication terminal, an embedded type communication device and a storing medium, and more particularly to a mobile communication terminal, an embedded type communication device and a storing medium which can send a proper electric power even by using a general-purpose communication terminal and perform accurate billing processing, especially when using the Internet and the like.

### BACKGROUND ART

Due to the information communication network such as the Internet, a user can receive various services by using a mobile communication terminal such as a portable phone, a PHS (Personal Handyphone System), a PDA (Personal Digital Assistant), or the like.

With the spread of these services, means which a user can use in order to enter the information communication network is assumed to expand from a mobile communication terminal and a personal computer further to the domestic electronic equipment such as a TV set.

In the future, there is a high possibility that almost all the electronic equipment are provided with functions to perform the supply of information, the purchase or rental of a charged product from a service provider through an information communication line, and therefore the importance of the authentication of a client increases more. For example, it becomes difficult to authenticate an object person to be charged for a conference room of the public facilities which can be used by many and unnamed persons.

A user who is moving outdoors or the like makes use of the mobile communication terminal mainly as a telephone, and therefore there is a need of improvements regarding mistakes in operation of input keys caused by downsizing, restriction of the memory amount or display area a power thrifty control and the like.

While, indoors for example in a house or an office, it is preferable for a user to use proper electronic equipment to receive such services in order to avoid the above problems. However, in such case, there arises a problem that the electronic equipment other than the mobile communication terminal has to have a subscriber line. For example, when a user gets the data about a stock price by using the mobile communication terminal, the most important details of a line graph and the like may not be recognized nor displayed because of restriction of the display area. At this time, if a user tries to display the same details on a large screen of a TV set in his or her house, the TV set will need a subscriber line as well.

An object of the present invention is to provide a mobile communication terminal, an embedded type communication device and a storing medium for sending a proper electric power and performing accurate billing processing even by using a general-purpose communication terminal, when using the Internet.

### DISCLOSURE OF THE INVENTION

In order to achieve the object, the mobile communication terminal of the present invention comprises mobile communication means for performing mobile communication, sending means for sending inherent information about a subscriber line, and power control means for differentiating transmission power between transmission by the mobile communication means and transmission by the sending means.

The mobile communication terminal further comprises protocol switching means for differentiating protocol between the transmission by the mobile communication means and the transmission by the sending means. Therefore, the optimum protocol can be adopted respectively in the case of performing the mobile communication and in the case of sending the inherent information.

The present invention comprises first communication means for receiving inherent information about a subscriber line by communication with the mobile communication terminal, second communication means for communicating with a service provider based on the inherent information received by the first communication means, and power control means for differentiating transmission power between transmission by the first communication means and transmission by the second communication means.

The present invention further comprises protocol switching means for differentiating protocol between the transmission by the first communication means and the transmission by the second communication means. Therefore, the optimum protocol can be adopted respectively in the case of sending the inherent information and in the case of performing communication with the service provider.

A computer readable storing medium of the present invention stores a program for working a computer as a mobile communication terminal which comprises mobile communication means for performing mobile communication, sending means for sending inherent information about a subscriber line, and power control means for differentiating transmission power between transmission by the mobile communication means and transmission by the sending means.

A computer readable storing medium of the present invention stores a program for working a computer as an embedded type communication device, which comprises first communication means for receiving inherent information about a subscriber line by communication with the mobile communication terminal, second communication means for communicating with a service provider based on the inherent information received by the first communication means and power control means for differentiating transmission power between transmission by the first communication means and transmission by the second communication means.

Since the mobile communication terminal and the radio device of the embedded type communication device use the same radio method, a large amount of the components can be shared between the two, thereby saving the manufacturing cost, weight, volume, power consumption and the like.

### BRIEF DESCRIPTION OF THE DRAWINGS

FIG. 1 is a view showing the concept of a communication system for accommodating a mobile communication terminal and an embedded type communication device according to an embodiment of the present invention.

FIG. 2 is a block diagram showing the structure of a mobile communication terminal according to the embodiment of the present invention.

FIG. 3 is a block diagram showing the structure of an embedded type communication device according to the embodiment of the present invention.

FIG. 4 is a function block diagram showing the structure of a mobile communication terminal according to the embodiment of the present invention.

FIG. 5 is a function block diagram showing the structure of an embedded type communication device according to the embodiment of the present invention.

FIG. 6 is a flow chart for illustrating the operation of the communication system for accommodating the mobile communication terminal and the embedded type communication device according to the embodiment of the present invention.

### BEST MODE FOR CARRYING OUT THE INVENTION

Hereinafter, preferred embodiments of the present invention will be described in detail in accordance with the attached drawings.

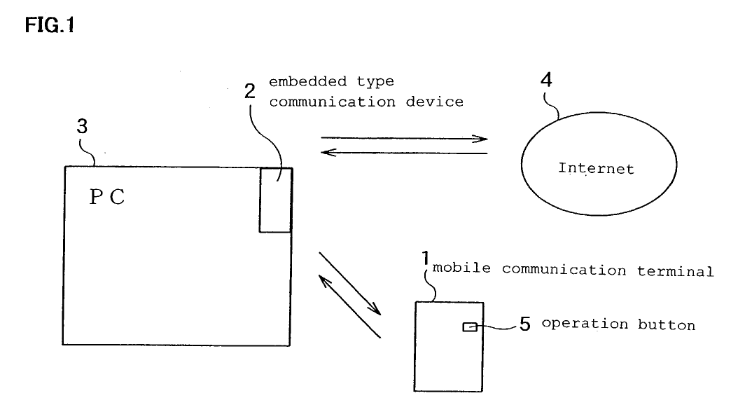

FIG. 1 is a view showing the concept of a communication system for accommodating a mobile communication terminal and an embedded type communication device according to the embodiment of the present invention.

The embedded type communication device 2 according to the embodiment of the present invention is formed integrally with electronic equipment (a personal computer (PC) 3 in FIG. 1), in order to establish communication with the Internet 4, in place of a mobile communication terminal 1.

The embedded type communication device 2 is embedded within the casing of the electronic equipment (PC 3) as illustrated in FIG. 1 and integrated with it, by being electrically connected with a circuit for realizing a function of the electronic equipment itself, or electrically connected with a circuit for realizing functions of the electronic equipment through an interface portion such as a connector or the like (not illustrated).

The communication system shown in FIG. 1 comprises electronic equipment such as PC 3, an embedded type communication device 2 provided in the electronic equipment, a mobile communication terminal 1, and an information communication network such as the Internet 4 and the like for providing various information and services such as charged or rental goods.

The electronic equipment applied to the PC3 is the equipment used in an ordinary house, an office, or a public place, and in this embodiment, the PC3 has a hardware structure connectable to the information communication network such as the Internet 4 and the like.

The mobile communication terminal 1 is a telephone having a subscriber line such as a portable phone and a PHS, and in this embodiment, an operation button 5 1 is provided for operating power restriction means for restricting the output power of a radio device of the mobile communication terminal 1 below the power defined by the radio wave regulation and means for sending the inherent information about a subscriber line to request the information to the equipment which provides a service.

The mobile communication terminal 1 sends the ID regarding a subscriber line to the embedded type communication device 2 by the operation button 5, in order to request services to the PC3 which connects with the information communication network such as the Internet 4 and the like which supplies services such as various information service and charged or rental goods. The communication line for communicating the ID is different from a general subscriber line and the output power of a radio device is restrained below the power defined by the radio wave regulation. The transmission and reception in the subscriber line of the mobile communication terminal 1 are suppressed and the first protocol for the use of the transmission and reception in the subscriber line is exclusively switched over to the second protocol, thereby making it possible to perform only the transmission and reception to and from the embedded type communication device 2. The details thereof will be described later.

Control transfer processing will be described hereinafter. Control transfer is that the mobile communication terminal 1 transfers a communication control for the Internet 4 to the embedded type communication device 2. The mobile communication terminal 1 sends the ID regarding the subscriber line to the embedded type communication device 2 and the embedded type communication device 2 establishes the subscriber line of the mobile communication terminal 1 between the PC3 (embedded type communication device 2) and the Internet 4. At this time, the embedded type communication device 2 regards the owner of the mobile communication terminal 1 as a charged person for the service of the Internet 4 and allows only the mobile communication terminal 1 (or the owner) to use the PC3.

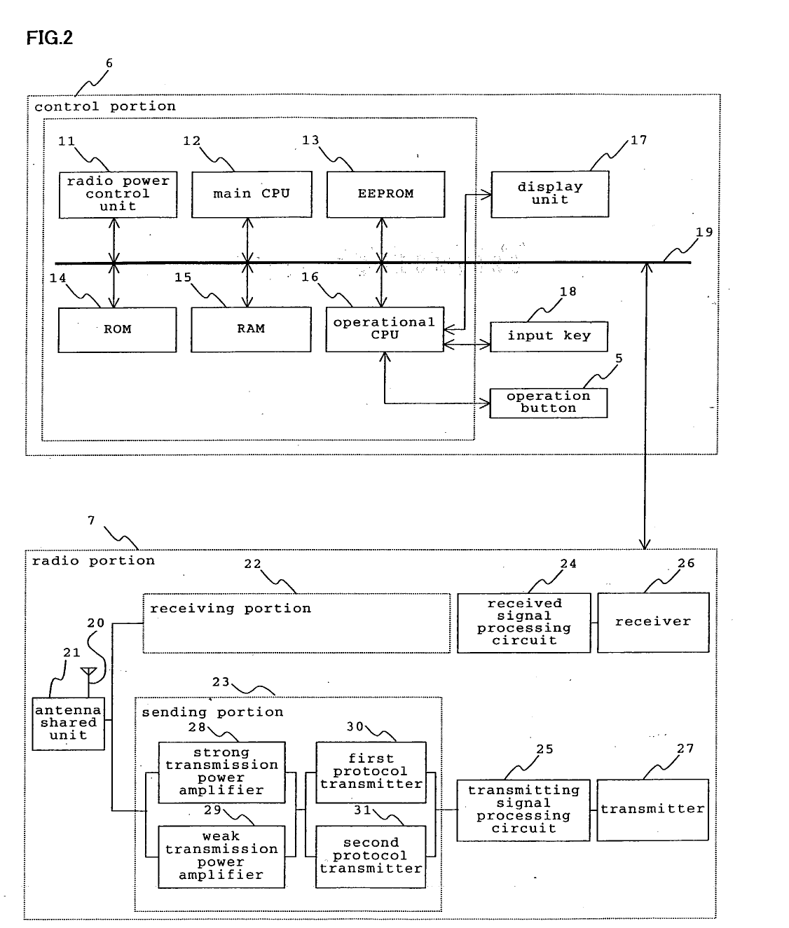

FIG. 2 is a block diagram showing the structure of the mobile communication terminal 1 according to the embodiment of the present invention. This mobile communication terminal 1 comprises a control portion 6 and a radio portion 7. In the radio portion 7, a signal received through an antenna 20 is supplied to a receiving portion 22 through an antenna shared unit 21. Then, it is processed by a received signal processing circuit 24, and supplied to a receiver 26 or a display unit 17 through the control portion 6.

While, the sound signal from a transmitter 27 or the input data from the control portion 6 is processed by a transmitting signal processing circuit 25, and thereafter, transferred in the first protocol from a first protocol transmitter 30 of a sending portion 23. It is then amplified by a strong transmission power amplifier 28 and sent from the antenna 20 through the antenna shared unit 21.

When the operation button 5 of the present invention (refer to FIG. 1) is operated, the input data from the control portion 6 is processed by the transmitting signal processing circuit 25, and thereafter transferred in the second protocol by a second protocol transmitter 31 of the sending portion 23. It is then amplified by a weak transmission power amplifier 29 for realizing the amplification so that a transmitting signal can be received by the embedded type communication device 2 in a predetermined detectable distance, and sent from the antenna 20 through the antenna shared unit 21. When the operation button 5 of the present invention is operated, the input data from the control portion 6 is switched to the second protocol effective between the mobile communication terminal 1 and the embedded type communication device 2. This can be realized by, for example, the protocol of the Bluetooth.

The control portion 6 includes a main CPU (Central Processing Unit) 12 for controlling the whole of the mobile communication terminal 1, a ROM 14 for storing a control program, a predetermined constant and the like, a RAM 15 used as a working area, an EEPROM 13 that is an electrically erasable and writable memory such as a flash memory for storing various parameters and tables, an operational CPU 16 for performing the data output to an input key 18 and a display unit 17, and a power control unit 11 for controlling the power-on/off for the mobile communication terminal 1, and these components are mutually connected by one another through a bus 19.

The control portion 6 performs the control of the general sending and receiving sequence operation of a subscriber line, the modulation and demodulation of a sending and receiving signal, the control of the sending and receiving protocol, the processing for displaying the received information or various information for an operator on the display unit 17, the processing for displaying various information which is supplied from the input key 18, on the display unit 17, the processing for supplying the data supplied from the input key 18 to the transmitting signal processing circuit 25, and the other control of the whole operation of the mobile communication terminal 1.

When the operation button 5 of the present invention is operated, the control portion 6 performs the control of the sending and receiving protocol and the control of the sending and receiving sequence operation conformable to the embedded type communication device 2, which are different from the controls of the general subscriber line, exclusively to the general subscriber line.

Although the operation button 5 of the present invention is made as an independent button, it may be replaced with the operation of the input key 18.

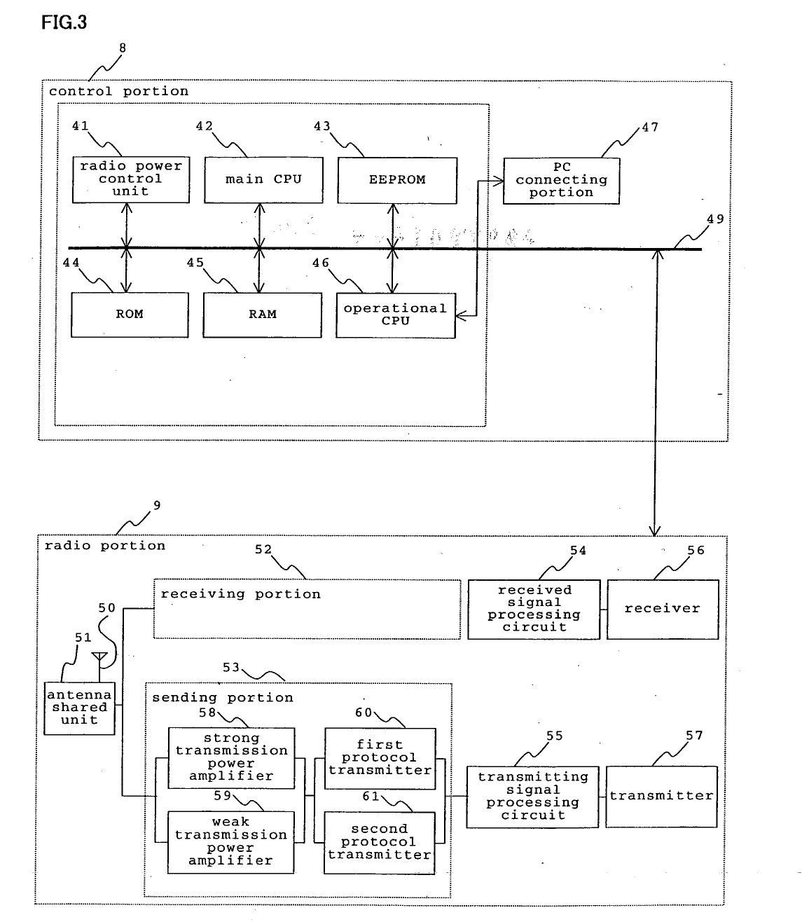

FIG. 3 is a block diagram showing the structure of the embedded type communication device 2 according to the embodiment. This structure is similar to the main structure of the mobile communication terminal 1 shown in FIG. 2. In the embedded type communication device 2, a signal received by an antenna 50 is supplied to a receiving portion 52 through an antenna shared unit 51. Then, it is processed by a received signal processing circuit 54.

While, the input data from a control portion 8 is processed by a transmitting signal processing circuit 55 according to an instruction of the control portion 8, and then, transferred in the second protocol by a second protocol transmitter 61 of a sending portion 53. It is then amplified by a weak transmission power amplifier 59 for realizing the amplification so that a transmitting signal can be received by the mobile communication terminal 1 in a predetermined detectable distance, and sent from the antenna 50 through the antenna shared unit 51.

The control portion 8 of the present invention performs communication according to the second protocol effective between the mobile communication terminal 1 and the embedded type communication device 2.

The signal received by the antenna 50 is supplied to a receiving portion 52 through the antenna shared unit 51, and processed by the received signal processing circuit 54.

The control portion 8 includes a main CPU (Central Processing Unit) 42 for controlling the whole of the embedded type communication device 2, a ROM 44 for storing a control program, a control transfer program for performing the control transfer processing of the present invention, a predetermined constant and the like, a RAM 45 used as a working area, an EEPROM 43 that is an electrically erasable and writable memory such as a flash memory which stores various parameters and tables, an operational CPU 46 for performing the data input/output to and from a PC connecting portion 47, and a power control unit 41 for controlling the power-on/off for the embedded type communication device 2, and these components are mutually connected by one another through a bus 49.

The control portion 8 performs the control of the sending and receiving protocol, the modulation and demodulation of the transmitted and received signal, and the control of the sending and receiving sequence operation, which are conformable to the embedded type communication device 2 and different from the controls of the general subscriber line. The control portion 8 performs the processing for communicating the received information or various information according to the instruction of the control portion 8 with the PC3 through the PC connecting portion 47, the sending and receiving processing of ID according to the instruction of the control portion 8, and the sending and receiving processing of the data between a predetermined site of the Internet 4 and the PC3 through the communication processing with the PC 3 via the PC connecting portion 47 by using the subscriber line of the mobile communication terminal 1. Further, it controls the other operation of the whole embedded type communication device 2.

The control portion 8 is only enough to control the sending and receiving protocol and the sending and receiving sequence operation conformable to the embedded type communication device 2, which are different from those of the general subscriber line. When communication between the PC3 and the Internet 4 is performed through the embedded type communication device 2, it can be easily realized by adding a control program to perform a control conformable to the general subscriber line to the ROM 44.

By making the structure of the embedded type communication device 2 the same as the main structure of the mobile communication terminal 1, a large number of the components can be shared, thereby saving the manufacturing cost, weight, volume, and power consumption.

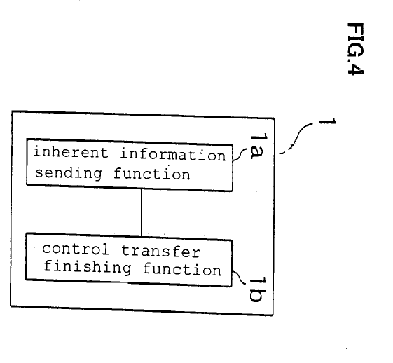

FIG. 4 is a function block diagram for illustrating the function of the mobile communication terminal 1 when the operation button 5 is operated. The mobile communication terminal 1 is realized by an inherent information sending function 1a and a control transfer finishing function 1b. These functions are realized in the control portion 6 or according to an instruction from the control portion 6.

In the inherent information sending function 1a, the control portion controls the sending portion to send the ID by operating the operation button 5 of the mobile communication terminal 1. The control portion 6 performs exclusively the control of the sending and receiving protocol, the control of the sending and receiving sequence operation conformable to the embedded type communication device 2 and the like, which are different from those of the general subscriber line.

In the control transfer finishing function 1b, the control portion 6 controls the receiving portion 22 to perform the receiving processing of a report informing that the embedded type communication device 2 has completed the receiving processing of the ID. After confirming that the ID has been received by the embedded type communication device 2, the control portion 6 displays the connection success on the display unit 17 of the mobile communication terminal 1, and returns the control of the sending and receiving protocol, the control of the sending and receiving sequence operation conformable to the embedded type communication device 2 and the like to the control of the sending and receiving protocol, the control of the sending and receiving sequence operation conformable to the subscriber line and the like, hence returning to the operation state as the general subscriber line.

The control portion 6 controls the receiving portion 22 to perform the receiving processing of a report informing that the embedded type communication device 2 has completed the receiving processing of the ID. When the report for confirming that the ID has been received by the embedded type communication device 2 is not received within a predetermined time, the control portion 6 displays the connection failure on the display unit 17 of the mobile communication terminal 1, and returns the control of the sending and receiving protocol, the control of the sending and receiving sequence operation conformable to the embedded type communication device 2 and the like to the control of the sending and receiving protocol, the control of the sending and receiving sequence operation conformable to the subscriber line and the like, hence returning to the operation state as the general subscriber line.

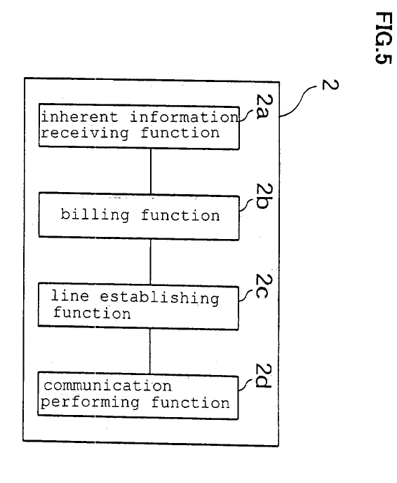

FIG. 5 is a function block diagram for illustrating the function of the embedded type communication device 2. The embedded type communication device 2 is realized by an inherent information receiving function 2a, a billing processing function 2b, a line establishing function 2c and a communication performing function 2d. These functions are realized in the control portion 8 or according to an instruction from the control portion 8.

In the inherent information receiving function 2a, the control portion 8 controls the receiving portion 52 to perform the receiving processing of the ID, and controls the sending portion 53 to inform the mobile communication terminal 1 that the receiving processing of the ID has been completed.

In the billing processing function 2b, the control portion 8 controls the PC3 through the PC connecting portion 47 based on the recognized ID. For example, the control portion 8 controls the display unit (not illustrated) such as LCD and the like to display the confirmation items about the use and connection of the Internet 4. Depending on the form of the use of the PC3 by a user of the mobile communication terminal 1, it controls the display unit to properly display the confirmation items about a bill. It performs the logging properly.

In the line establishing function 2c, the control portion 8 controls the PC3 through the PC connecting portion 47, after the billing processing function 2b, and then establishes a user's subscriber line between the user and a service provider corresponding to the form of use which is selected by the user. For example, the control portion 8 connects with the Internet 4 by using a built-in modem (not illustrated) of the PC3, and establishes a communication line between the user and a site of a predetermined service provider according to the user's input operation. Alternatively, it may connect the embedded type communication device 2 with a site of a service provider through a subscriber line, to perform the communication between the PC3 and the Internet 4 through the embedded type communication device 2.

In the communication performing function 2d, the control portion 8 monitors a user's input operation for the PC3. For example, the control portion 8 controls the modem of the PC3, or the sending portion 53 and the receiving portion 52 of the embedded type communication device 2, depending on the use form, to perform the data communication in response to the user's operation.

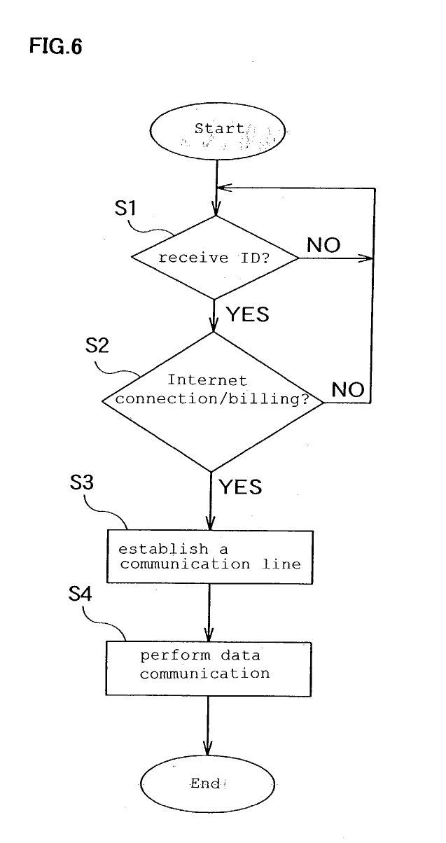

FIG. 6 is a flow chart for illustrating the operation of the communication system for accommodating the mobile communication terminal 1 and the embedded type communication device 2 according to the present embodiment. FIG. 6 mainly indicates the operation of the embedded type communication device 2.

At first, in Step S1, the mobile communication terminal 1 determines whether or not the embedded type communication device 2 has received the ID sent by the same terminal 1, by operating the operation button 5 within a predetermined detectable distance in which the ID can be detected from the embedded type communication device 2. When the same device 2 has not received the ID, this step will be repeated, while when it has received the ID, this step will be advanced to the processing of Step S2.

In Step S2, the use of a service of the Internet 4 is confirmed by the owner of the received ID that is a user. In this processing, as mentioned above, the mobile communication terminal 1 is notified that the receiving processing of the ID has been completed, and the confirmation items of a bill regarding the Internet connection and the service using time of the user are displayed on the display unit of the PC3.

In Step S2, for example, when a user's confirmation is not received within a predetermined time, this step will be returned to the processing of Step S1, while when a user's confirmation is received within a predetermined time, this step will be advanced to the processing of Step S3 with the user regarded as a charged person.

In Step S3, a communication line is established between a site of a service provider according to a user's input operation and the user, by using the user's subscriber line. As mentioned above, the user that is an owner of the mobile communication terminal 1 can get access to the site of a predetermined service provider from the PC3 by using the established communication line. The communication line is the user's subscriber line and the service provider can bill the user for the cost for providing the Internet 4 services.

In Step S4, the user's input operation for the PC3 is monitored, and the data communication is performed. For example, when the use form is “getting information”, the data sending/receiving processing is performed in the process that the necessary data is downloaded from the site which the user is getting access to. When the use form is “rental”, the data sending/receiving processing is performed in the process that the goods to borrow is selected and the rental period and the rental charge are decided.

The charged information generated in the process of Step S4 is transferred from the service provider to a control server (not illustrated) which concentrates the billing affairs, thereby sending a bill to the user after predetermined elapse of time.

As mentioned above, the mobile communication terminal 1 and the embedded type communication device 2 can authenticate the charged person accurately when there are many and unnamed clients who want to receive the Internet 4 services by using the PC3. This can be realized by providing the electronic equipment such as PC3 and the mobile communication terminal 1 with a new additional function (the embedded type communication device 2, the operation button 5, and the like).

The present invention can be realized by changing the structure and/or the operation, and/or further by expanding a function newly. Hereinafter, these points will be described.

In the above mentioned embodiment, the embedded type communication device 2 is connected with the PC3 connectable with the Internet 4 to mediate the providing of services such as getting information, borrowing the rental goods or purchasing the goods. The electronic equipment in which the embedded type communication device 2 of the present invention is incorporated is not restricted to the PC3.

For example, when the electronic equipment is a TV set, the information obtained by using a subscriber line of the mobile communication terminal 1 can be displayed on the television screen by adding a function connectable to the Internet 4 like the Set Top Box to the TV set.

When the electronic equipment is a game machine set in an amusement arcade, a user can play the game without cash by adding a function connectable to the Internet 4 to the game machine and charging the subscriber line of the mobile communication terminal 1a for the fee depending on the play time of a game or the number of the play.

When the electronic equipment is an office equipment of the public institution, or a game machine of an amusement arcade and there are a plurality of embedded type communication devices 2 nearby, the ID of an objective electronic equipment is specified by the input key 18 and the operation button 5 is operated, thereby receiving a desired service.

The storing medium in which a program for executing the operation of the embedded type communication device 2 is stored may be the ROM 44 itself shown in FIG. 3. Alternatively, with a program reading device (not illustrated) such as a CD-ROM drive and the like provided as the external storage, it may be a CD-ROM or the like which is inserted therein to read the program. The storing medium may be a hard disk, a semiconductor memory, and the like.

Instead of the strong transmission power amplifier and the weak transmission power amplifier, one amplifier may be used to change the amplification factor.

According to the present invention, at a use of the information communication network such as the Internet and the like, it is possible to send a proper power even by using the general-purpose communication terminal, and perform the accurate billing processing, which can contribute the improvement in a service for a user. This is why the embedded type communication device is provided in the electronic equipment which is operated at a use of the Internet and the inherent information is exchanged between the embedded type communication device and the mobile communication terminal in a simple way.

Since the output power of a radio device can be restricted below the power defined by the radio wave regulation by the operation of the operation button, it is possible to form the mobile communication terminal and the embedded type communication device in the same structure with the same function, and share a large number of the components in the respective devices, thereby saving the manufacturing cost, weight, volume, and power consumption.

Further, since a large number of the components can be shared between the mobile communication terminal and the embedded type communication device, the manufacturing cost, weight, volume, and power consumption can be saved.

Industrial Applicability

The present invention is to provide a mobile communication terminal which sends a proper power and performs accurate billing processing even by using the general-purpose communication terminal, at a use of the Internet and the like.

1. A mobile communication terminal comprising: mobile communication means for performing mobile communication; sending means for sending inherent information about a subscriber line; and power control means for differentiating transmission power between transmission by the mobile communication means and transmission by the sending means.

2. The mobile communication terminal according to claim 1, further comprising protocol switching means for differentiating protocol between the transmission by the mobile communication means and the transmission by the sending means.

3. An embedded type communication device comprising: first communication means for receiving inherent information about a subscriber line through communication with the mobile communication terminal; second communication means for communicating with a service provider based on the inherent information received by the first communication means; and power control means for differentiating transmission power between transmission by the first communication means and transmission by the second communication means.

4. The embedded type communication device according to claim 3, further comprising protocol switching means for differentiating protocol between the transmission by the first communication means and the transmission by the second communication means.

5. A computer readable storing medium which stores a program for working a computer as a mobile communication terminal, said mobile communication terminal comprising: mobile communication means for performing mobile communication; sending means for sending inherent information about a subscriber line; and power control means for differentiating transmission power between transmission by the mobile communication means and transmission by the sending means.

6. A computer readable storing medium which stores a program for working a computer as an embedded type communication device, said embedded type communication device comprising: first communication means for receiving inherent information about a subscriber line through communication with the mobile communication terminal; second communication means for communicating with a service provider based on the inherent information received by the first communication means; and power control means for differentiating transmission power between transmission by the first communication means and transmission by the second communication means.
